(19) United States
(12) Patent Application Publication
(10) Pub. No.: US 2017/0258047 A1
(43) Pub. Date: Sep. 14, 2017

(54) THROWING APPARATUS AND METHOD

(71) Applicant: Doskocil Manufacturing Company, Inc., Arlington, TX (US)

(72) Inventors: Ryan WILLS, Carrollton, TX (US); Kyle BURGER, Seattle, WA (US)

(21) Appl. No.: 15/067,442

(22) Filed: Mar. 11, 2016

(51) Int. Cl. A01K 15/02; G01S 5/00; G01S 19/13; A63B 59/20

(52) U.S. Cl. CPC A01K 15/027; A63B 59/20; G01S 5/0072; G01S 19/13; H04B 10/11

(57) ABSTRACT

A throwing apparatus includes a head portion configured to engage a ball, a handle portion configured for holding the throwing apparatus, and a communication portion configured to transmit a signal. A throwing system includes a throwing apparatus including a thrower portion configure to engage a ball, a communication portion enabling a user to assist in locating a ball, and a ball. A throwing method includes holding a throwing apparatus including a thrower portion configured to engage a ball and a communication portion, engaging a ball, swinging the throwing apparatus to throw the ball, choosing between the following: swinging a throwing apparatus to throw the ball to another person or swinging a throwing apparatus to throw the ball to a pet, and engaging the ball.

### BACKGROUND

Field of the Invention

The invention generally relates to a throwing apparatus, system, and method. More specifically, the present invention relates to a throwing apparatus, system, and method used for recreational activities and exercise for people and animals.

Background Information

Pet owners use a variety of apparatuses, systems, and methods to engage in recreational activities and exercise with pets. Additionally, pet owners and their pets can get exercise from engaging in recreational activities with pets using various pet toys or devices. People (users) other than pet owners can also use pet toys and devices. Pet owners and these users can also provide exercise for pets by engaging in recreational activities with other users or pet owners.

Conventional pet throwing apparatuses and methods allow users to engage in recreational activities wherein the user or users throw the ball or other object and their pet or pets search for and identify the ball using available daylight. Conventional throwing apparatuses and methods include throwing and resetting the ball into the thrower before throwing again.

### SUMMARY

It has been discovered that a throwing system for playing with pets including a communication portion to communicate with a ball or other thrown object can improve the quality of the recreational activities of users and pets. It has also been discovered that a throwing apparatus used when playing with pets that can communicate with a ball or other thrown object can extend the available time in which users and pets can engage in recreational activities.

In view of the state of the known technology, one aspect of the present disclosure is to provide a throwing apparatus including a head portion configured to engage a ball, a handle portion configured for holding the throwing apparatus, and a communication portion configured to communicate a signal.

Another aspect of the present disclosure is to provide a throwing system including a throwing apparatus comprising a thrower portion configured to engage and throw a ball, a communication portion configured to enable a user to assist in locating a ball, and a ball.

Another aspect of the present disclosure is to provide a method of playing with a pet including holding a throwing apparatus comprising a thrower portion configured to engage a ball, holding a communication portion to communicate with the ball, engaging the ball, and swinging the throwing apparatus to throw the ball to another user.

### BRIEF DESCRIPTION OF THE DRAWINGS

Referring now to the attached drawings which form a part of this original disclosure:

FIG. 1 is a perspective view of a throwing apparatus having a communication portion.

FIG. 2 is profile view of a throwing apparatus having a communication portion.

FIG. 3 is an exploded view of one embodiment of a throwing apparatus having a communication portion.

FIG. 4 shows a throwing apparatus transmitting a signal to a ball.

FIG. 5 shows a user using the throwing apparatus to communicate with a ball, assisting a pet in locating the ball.

FIG. 6 shows users using the throwing apparatus to play with a pet.

FIG. 7 shows separate portable electronic devices configured to communicate with the ball including an electronic watch, portable phone, and pet collar.

### DETAILED DESCRIPTION OF THE EMBODIMENTS

Selected embodiments will now be explained with reference to the drawings. It will be apparent to those skilled in the pet products field from this disclosure that the following descriptions of the embodiments are provided for illustration only and not for the purpose of limiting the invention as defined by the appended claims and their equivalents.

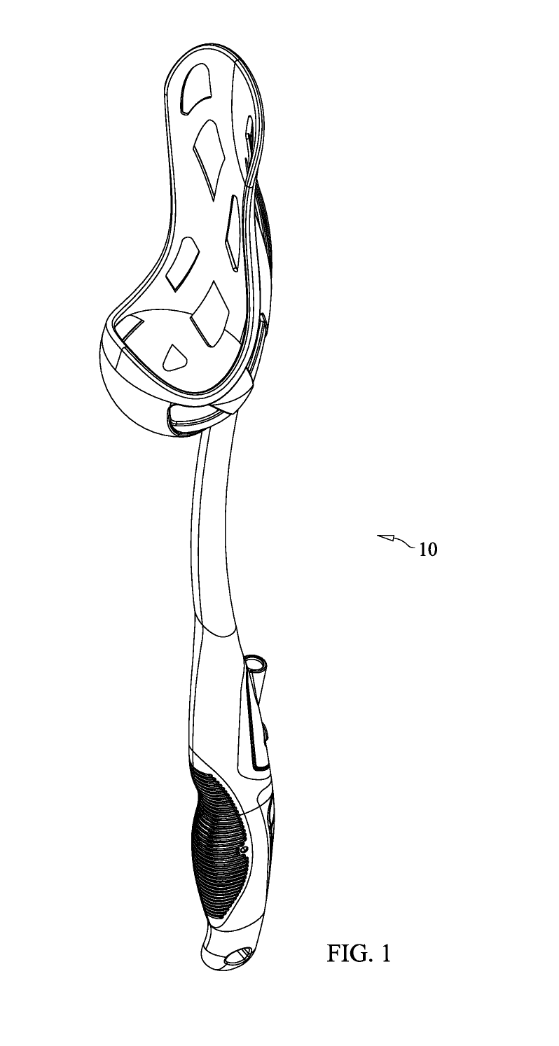

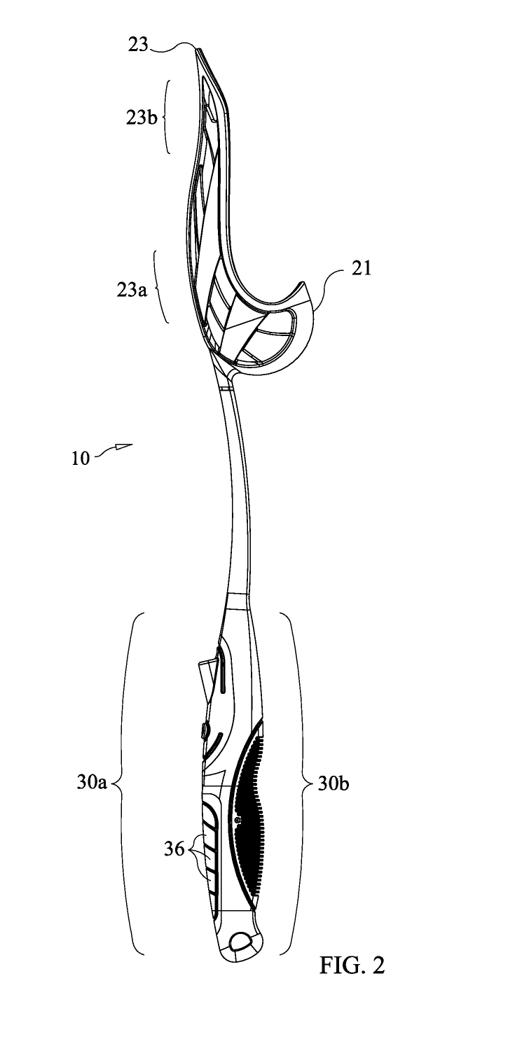

Referring initially to FIGS. 1-2, one embodiment of a throwing apparatus 10 includes a head portion 20 configured to engage a ball, a handle portion 30 for holding the throwing apparatus 10, and a communication portion 40 configured to transmit a signal.

The head portion 20 includes a basket 21 configured to engage a ball 50 , holes 22 in the head portion 20 to allow easier swinging of the throwing apparatus 10, and a ramped portion 23 so that the head portion 20 can be used to scoop up a ball 50 and to better direct the ball 50 when throwing.

As shown in FIGS. 1-3, the basket 21 is configured to engage different sizes of balls such as tennis balls or lacrosse balls. The basket 21 can include a semi-spherical portion with an opening 21a that communicates with the ramped portion 23. The semi-spherical portion generally has the same shaped or configuration as a portion of the outer surface of a ball 50, to enclose a portion of a ball 50 such that the ball 50 is securely held therein. It is noted that the semi-spherical portion can enclose any suitable outer surface area of the ball 50. Accordingly, the depth of the basket 21 can be configured so as to engage a ball 50 while a user is moving with the ball 50 inside the throwing apparatus 10 prior to throwing the ball 50.

The basket 21 includes a plurality of holes or openings 22 to allow users to engage balls more easily. The openings 22 preferably extend from a first or inner surface of the basket 21 to the second or outer surface of the basket 21.

The ramped portion 23 is connected to the basket 21 and is used to scoop up a ball 50. The ramped portion 23 is an elongated portion with an arcuate cross section. Accordingly, the ramped portion 23 forms a channel with upwardly curved sides that facilitates and assists in throwing, accelerating, and guiding a thrown ball 50. As shown in FIG. 2, the ramped portion 23 has a first curved portion 23a and a second curved portion 23b. The first curved portion 23a is adjacent the basket 21 and curves inwardly in the direction of the curvature of the basket 21. The first curved portion 23a has a radius of curvature that less than that of the basket 21; however, the radius of curvature of the first curved portion 23a can be any suitable radius. The second curved portion 23b curves outwardly relative to the first curved portion and facilitates scooping up and throwing of the ball 50.

Further, the ramped portion 23 is in communication with the basket 21 through opening 21a. Accordingly, when throwing a ball 50, the ball 50 moves from the basket 21 through the opening 21a and along the ramped portion 23. Conversely, when scooping up a ball 50, the ball 50 traverses the ramped portion 23, passing into the opening 21a and comes to rest in the basket 21.

The holes 22 can be formed in both the basket 21 and the ramped portion 23 allow for better engagement of a ball 50 by the basket 21, and allows for better swinging of the throwing apparatus 10. The holes 22 also add a sporty, aesthetic design.

The basket 21 and ramped portion 23 are made of a flexible and durable thermoplastic material.

The basket 21 and ramped portion 23 are connected to the handle portion 30. The handle portion 30 is a cylindrical-shaped portion curved to facilitate holding the apparatus comfortably when the user uses the throwing apparatus 10. The handle portion 30 is also curved to facilitate comfort for the user to transport the apparatus to location at which to the user plans to use the throwing apparatus 10. The handle portion 30 is shaped to facilitate throwing and catching for prolonged play times.

As shown in FIGS. 1-3, the handle portion 30 includes a handle lower cushion 31, a handle upper cushion 32, a handle upper cushion support 33, and a housing piece 34.

The handle portion 30 has an upper curved portion 30a and a lower curved portion 30b, the lower curved portion 30b including the handle lower cushion 31, and the upper curved portion 30a including the handle upper cushion 32 and the housing piece.

The lower curved portion 30b is contoured to provide a better form for holding. The handle lower cushion 31 is contoured to provide a good grip on the throwing apparatus 10. The handle lower cushion 31 also includes ridges 35 to further increase the comfort of holding the throwing apparatus 10. The handle lower cushion 31 also includes ridges to further increase the grip of the entire throwing apparatus 10. The handle lower cushion 31 includes a hard plastic inner shell that is stiff and lightweight. The hard plastic inner shell connects to the bottom of the handle portion 30. The hard plastic inner shell of the handle lower portion 31 includes an outer covering. The outer covering of the handle lower cushion 31 is made of a flexible, durable, and soft rubber.

The handle upper cushion 32 is contoured to increase the comfort of holding the throwing apparatus 10. The contouring of the handle upper cushion 32 includes smooth ridges 36 to comfortably increase the strength of a user's grip on the throwing apparatus 10. The ridges 36 of the handle upper cushion 32 are tapered towards the bottom of the throwing apparatus 10 to provide additional comfort in holding by the user. The handle upper cushion 32 is made of a hard plastic. The handle upper cushion 32 is attached to the handle upper cushion support 33. The handle upper cushion support 33 is made of hard plastic and provides a base for the handle upper cushion 32, connecting it to the handle portion 30. The handle upper cushion support 33 and the handle upper cushion 32 also cover the batteries 46 that power the communication portion 40.

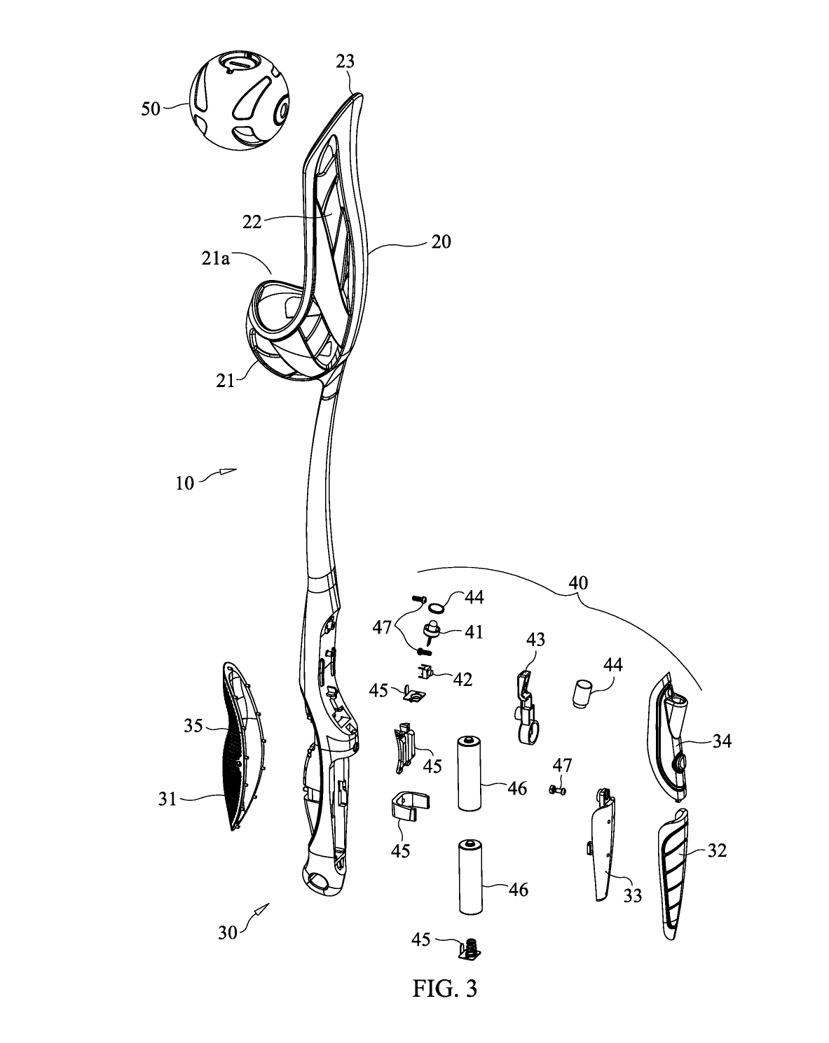

The upper curved portion 30a of the handle portion 30 includes an area for attaching the communication portion 40 above the area of the handle portion 30 where the handle upper cushion 32 is attached. As shown in FIG. 3, handle portion 30 includes support and spacing for the components of the communication portion 40.

As shown in FIG. 3, the communication portion 40 is configured to transmit a signal and comprises a transmitter 41, a transmitter switch 42, a transmitter trigger 43, a transmitter lens assembly 44, transmitter housing components 45, batteries 46, and screws 47.

The transmitter 41 is a standard infrared light emitter using conventional components. The transmitter switch 42 is a conventional component connected to the transmitter trigger 43. The transmitter lens assembly 44 covers the transmitter 41 and is mounted on the transmitter trigger 43 which is covered by the housing piece 34. The transmitter lens assembly 44 is made of clear plastic and can be colorless or colored.

The transmitter housing components 45 are standard conventional transmitter components that connect the transmitter 41, the transmitter switch 42, the transmitter trigger 43, the transmitter lens assembly 44, and the batteries 46 to the handle portion 30 by screws 47. The transmitter housing components 45 are made of a flexible and durable plastic material. The batteries 46 are conventional batteries for handheld devices such as AA or AAA batteries.

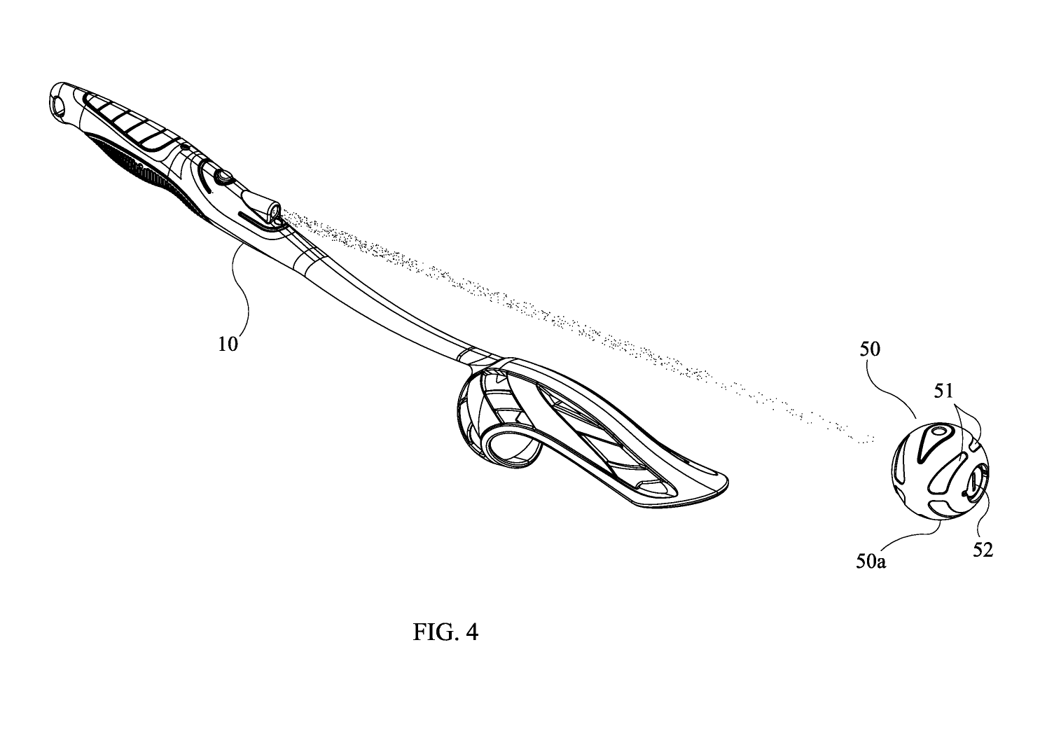

FIG. 4 shows one embodiment of a throwing apparatus 10 communicating with a ball 50.

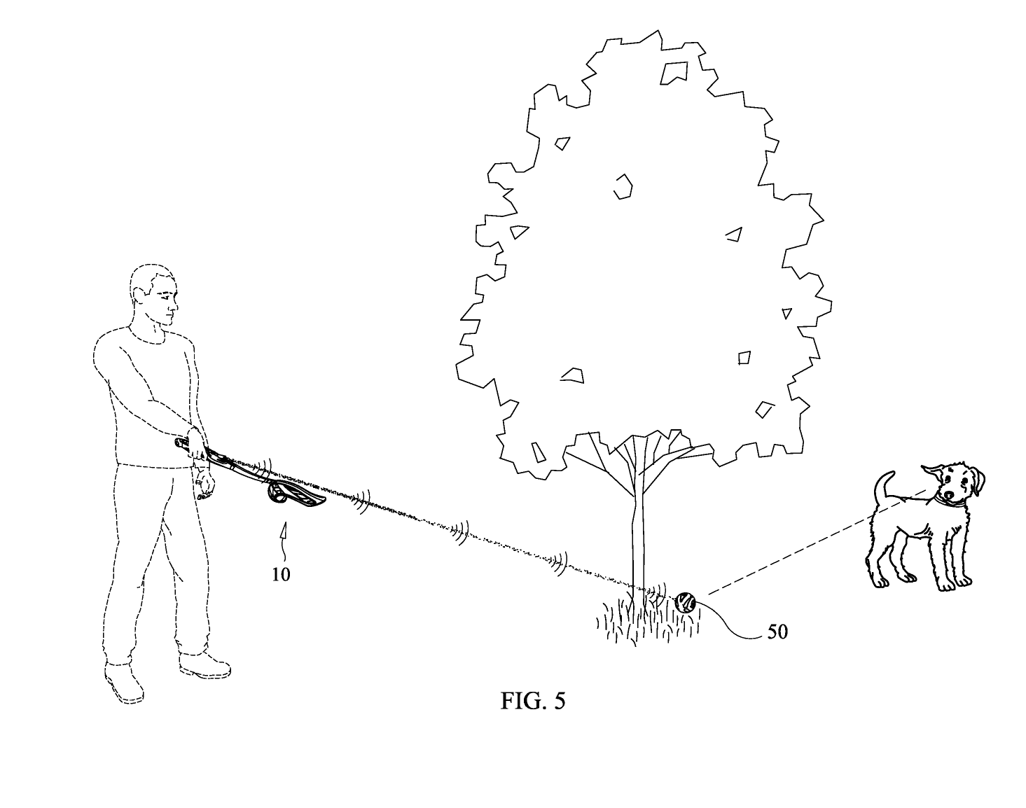

Referring initially to FIGS. 4-5, a throwing apparatus 10 is illustrated that is equipped with a communication portion 40 in accordance with a first embodiment. The communication portion 40 communicates with the ball 50.

In one embodiment, the communication portion 40 transmits light to the ball 50 and illuminates the ball 50 for greater visibility of the ball 50 by the user and the pet. The ball 50 includes a plurality of holes 51 and a cylindrical insert 52 inside the center of the ball 50. The plurality of holes 51 allows light or other transmissions to illuminate the cylindrical insert 52 inside the center of the ball 50.

In one embodiment, the communication portion 40 transmits light to the ball 50 and illuminates the ball 50 for greater visibility of the ball 50 by the user and the pet. The ball 50 includes an outer covering 50a made of a material that reacts to infrared light or radio transmissions by illuminating the ball 50.

In another embodiment, the communication portion 40 transmits radio signals to the ball 50 and receives a response from the ball 50 which can provide information on the location of the ball 50 such as illumination of the ball 50 or the throwing apparatus 10. The ball 50 includes a cylindrical insert 52 inside the center of the ball 50 which contains a radio receiver and transmitter to receive and transmit signals, and a GPS device to provide location information.

In another embodiment, the communication portion 40 transmits signals to the ball 50 and receives a response from the ball 50 which can provide information on the location of the ball 50 to a separate portable electronic device 60 such as a phone, watch, or collar.

FIGS. 4-5 shows one embodiment of a throwing system.

Referring to FIGS. 4-5, a user can throw a ball 50 with the throwing apparatus 10 to engage a pet or pets in playing with the ball 50. The user throws the ball 50, the user can assist the pet in locating the ball 50, and the pet can return the ball 50.

As the play continues into the evening or in other low light or dark situations, users can use the communication portion 40 of the throwing apparatus 10 to illuminate or otherwise assist the pet and the user in locating the ball 50 as shown in FIG. 5.

The throwing system includes a throwing apparatus 10 comprising a throwing portion 20 configured to engage a ball 50, a ball 50, and a communication portion 40 configured to enable a user to assist in locating a ball. Preferably, the ball 50 is configured to be releasably retained by the throwing apparatus 10. The ball 50 can also be configured to comprise a communication device for communicating with the communication portion 40.

In one embodiment, the user can communicate with the ball 50 by pointing the throwing apparatus 10 in the direction of the ball 50, and pressing the trigger on the handle portion 30. The communication portion 40 of the throwing apparatus 10 preferably emits light signals to communicate with the ball 50. However, as can be appreciated, the communication portion 40 can use any other suitable transmission signals other than light signals such as radio signals. In such an embodiment, the user need not directly point the throwing apparatus 10 at the ball 50 to communicate the signals transmitted by the communication portion 40.

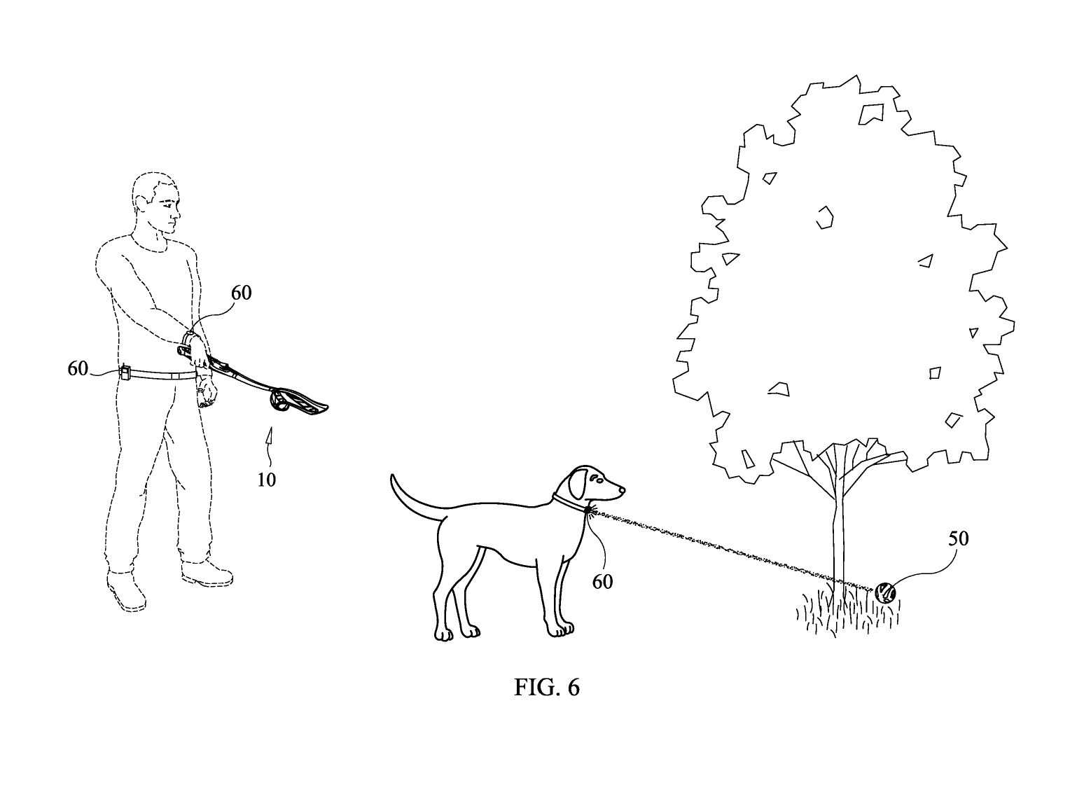

As shown in FIG. 5, the communication portion 40 is preferably attached to the throwing apparatus 10. As can be appreciated, however, as shown in FIG. 6, at least one component of the communication portion 40 can be located on a separate device such as a separate portable electronic device 60 or any other suitable device that can communicate with the ball 50. The communication portion 40 can comprise a component of the communication portion comprising separate portable electronic device 60 that is a phone with a software application for communicating with the ball 50 and another component of the communication portion 40 comprising a transmitter on the throwing apparatus 10.

The communication portion 40 can also comprise a component of the communication portion comprising separate portable electronic device 60 that is a watch with a software application for communicating with the ball 50.

As can be appreciated, a communication device worn by or attached to the pet such as a collar with a radio transmitter or receiver can be a suitable separate portable electronic device 60 substantially similar to other communication devices used in the communication portion 40.

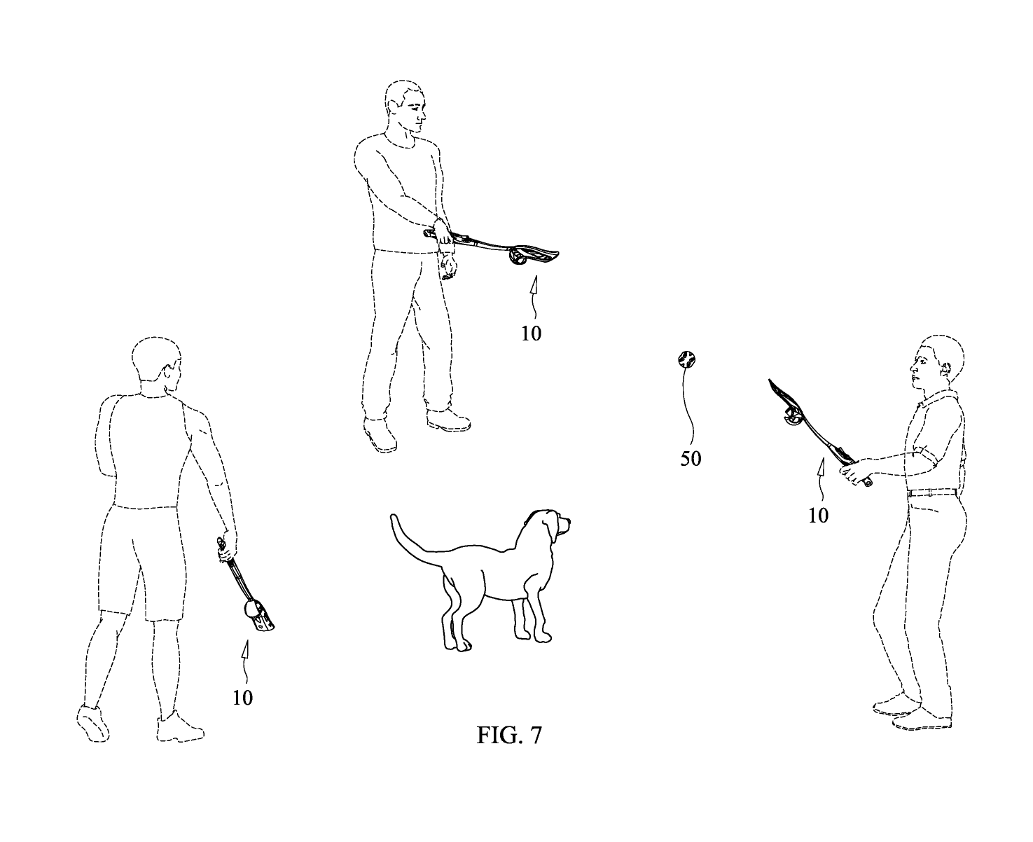

FIG. 7 shows a method of playing with a pet including a user holding a throwing apparatus 10 configured to engage a ball 50, engaging the ball 50, swinging the throwing apparatus 10 to throw the ball 50 to another person (user). However, a user can swing the throwing apparatus 10 to throw the ball 50 around with any number of users who can throw the ball 50 back and forth for a pet or pets to chase. Further, a user can instead throw the ball 50 towards an area where the pet can fetch the ball 50.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” or “element” when used in the singular can have the dual meaning of a single part or a plurality of parts.

The term “configured” as used herein to describe a component, section or part of a device includes hardware and/or software that is constructed and/or programmed to carry out the desired function.

The terms of degree, such as “substantially” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, and including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. An apparatus for throwing objects, comprising:
a head portion configured to engage a ball;
a handle portion configured for holding the throwing apparatus; and
a communication portion configured to transmit a signal.

2. The apparatus of claim 1, wherein the head portion is further configured to frictionally engage a ball.

3. The apparatus of claim 1, wherein the head portion is further configured to frictionally engage a disc.

4. The apparatus of claim 1, wherein the communication portion is configured to transmit a radio wave signal.

5. The apparatus of claim 1, wherein the communication portion is configured to transmit an infrared light signal.

6. The apparatus of claim 1, wherein the communication portion enables a user to locate a ball.

7. A throwing system, comprising:
a throwing apparatus comprising a thrower portion configured to engage a ball;
a communication portion configured to enable a user to assist in locating a ball; and
a ball.

8. The throwing system of claim 7, wherein the ball is configured to communicate with a communication portion.

9. The throwing system of claim 7, wherein the ball is configured to be releasably retained by the throwing apparatus.

10. The throwing system of claim 7, wherein the ball comprises a device for responding to communication from a communication device.

11. The throwing system of claim 7, wherein at least one component of the communication portion is separated from the throwing apparatus.

12. The throwing system of claim 11, wherein the communication portion is configured to be attached to a pet.

13. A method of playing with a pet, comprising:
holding a throwing apparatus comprising a thrower portion configured to engage a ball;
engaging the ball;
swinging the throwing apparatus to throw the ball; and
triggering a communication portion to communicate with the ball.

14. The method of playing with a pet in claim 13, wherein the swinging the throwing apparatus to throw the ball comprises swinging the throwing apparatus to throw the ball to another person.

15. The method of playing with a pet in claim 13, wherein the swinging the throwing apparatus to throw the ball comprises swinging the throwing apparatus to throw the ball to a pet.

16. The method of playing with a pet in claim 14, wherein the swinging the throwing apparatus includes one of:
swinging the throwing apparatus to throw the ball to another person; and
swinging the throwing apparatus to throw the ball to a pet; and
engaging the ball.
